(19) United States
(12) Patent Application Publication
(10) Pub. No.: US 2012/0232876 A1
(43) Pub. Date: Sep. 13, 2012

(54) Method for Computer-Aided Analysis of an Automation Plant

(75) Inventor: Sandeep MISRA, Nurnberg (DE)

(73) Assignee: Siemens Aktiengesellschaft, Munchen (DE)

(21) Appl. No.: 13/229,224

(22) Filed: Sep. 9, 2011

(30) Foreign Application Priority Data
Sep. 10, 2010 (EP) EP10176176

(51) Int. Cl. G06F 17/50; G06G 7/62

(52) U.S. Cl. 703/13

(57) ABSTRACT

A method for computer-aided analysis of an automation plant to which a plurality of networked devices are assigned, wherein information pertaining to the networked devices including their device types and interconnections is acquired and a network topology is generated which represents the networking of the devices. A respective device is then assigned, according to its device type, to one hierarchy level of a plurality of hierarchy levels defined for the automation plant. A topology of the automation plant is then displayed on a user interface on which a section is provided for each hierarchy level, where devices assigned to a respective hierarchy level are disposed as elements in a section provided for the respective hierarchy level and are interconnected based on the networking according to the network topology.

### BACKGROUND OF THE INVENTION

1. Field of the Invention

The invention relates to computer aided design and, more particularly, to a method for computer-aided analysis of an automation plant and to a corresponding apparatus and computer program product.

2. Description of the Related Art

It is known to automatically determine the topology of a plurality of networked devices and to graphically visualize the determined topology. Based on suitable protocols, such as Simple Network Management Protocol (SNMP), information is read from the networked devices and used to determine the individual network connections between the networked devices. Based on this information, the networking of the devices can then be suitably reproduced on a display as a network topology with corresponding structures, such as stars, rings and/or trees.

In the context of operating automation plants, not only the networking of the devices is important, but also the function of the individual networked devices as part of the automation process performed with the automation plant. However, generating a network topology between the networked devices of an automation plant provides no indication of the functions of the networked devices in the automation plant and therefore of the topology of the plant.

### SUMMARY OF THE INVENTION

It is therefore an object of the invention to provide a method for automatically analyzing an automation plant having a plurality of networked devices such that the topology of the automation plant is visualized based on the functionalities of the individual networked devices.

This and other objects and advantages is achieved in accordance with the invention by an apparatus, computer program product and method that is used for computer-aided analysis of an automation plant to which a plurality of networked devices are assigned. These networked devices are a component part of the automation plant or devices that can communicate with the automation plant, e.g., devices from information networks linked to the automation plant.

In accordance with the invention, information pertaining to the networked devices, including their device types and interconnections, is acquired and a network topology is generated which represents the networking of the devices. For example, a central monitoring instance can be provided that gathers the information pertaining to the devices centrally by reading out the information, e.g., based on the Simple Network Management Protocol (SNMP). The information pertaining to the networked devices can be stored in the respective devices based on the Link Layer Discovery Protocol (LLDP). This protocol enables directly interconnected adjacent devices to exchange information that is then stored in the individual devices in a Management Information Base (MIB). As a result of the exchange of information between adjacent devices, the particular information about existing connections between the devices, is also obtained. It is generally known to generate a network topology from corresponding information pertaining to the devices and will therefore not be explained in greater detail. The network topology can be generated, e.g., using the “Sinema Server” Software of Siemens AG.

In accordance with the of the invention, after generation of the network topology, a respective device is assigned, according to its device type, to one of a plurality of hierarchy levels defined for the automation plant. A topology of the automation plant is then displayed on a user interface using a suitable display or screen. Here, the user interface is provided with a section for each hierarchy level, where the devices assigned to a particular hierarchy level are disposed as elements in a section provided for the respective hierarchy level and are interconnected based on the networking according to the network topology. Corresponding elements of the individual devices and their interconnections are therefore reproduced on the user interface, i.e., as suitable graphical representations (e.g., icons). The networking is displayed in particular based on the corresponding lines between the devices. Based on the method in accordance with the invention, a suitable automation plant topology is therefore derived from a network topology that does not take the types of the individual networked devices into account, where information relating to the device types of the individual devices is processed for this purpose.

In accordance with the invention, the hierarchical structure of the automation plant is defined in advance by suitably assigning devices or device types to hierarchy levels depending on the application. In a preferred embodiment, the hierarchical structure is based on a conventional automation pyramid. That is, one or more hierarchy levels correspond to levels from the automation pyramid, such as the field level, the control level or the process control level.

In particular, the hierarchy levels used in accordance with the disclosed embodiments of the invention specify the proximity of the devices disposed therein to the automation process of the automation plant: the lower the hierarchy level, the greater the proximity to the automation process. In other words, devices directly affecting the automation process are disposed in lower hierarchy levels than devices responsible for higher-order control functionalities, i.e., devices which, although networked with the automation plant, are not a direct component part of that plant.

In accordance with the contemplated embodiments of the method in accordance with the invention, the device type may not constitute the sole criterion by which a device is assigned to a hierarchy level. In particular, additional criteria such as the installation location of the respective device can also be taken into account for assigning the devices to hierarchy levels. For example, if the device is installed in a linked network at a location outside the automation plant, the device may be disposed in a higher hierarchy level than if the same type of device constitutes a direct component part of the automation plant.

In a particularly preferred embodiment of the method in accordance with the invention, the plurality of hierarchy levels comprises a field level and a control level, where devices directly involved in the automation process (e.g., manufacturing or production process) of the automation plant are assigned to the field level and devices indirectly involved in the automation process are assigned to the control level. The assignment is again dependent on the corresponding device types of the individual devices. The definition of whether a device is directly or only indirectly involved in the automation process can be suitably specified in advance, depending on the design of the automation plant. Normally, all sensors, actuators and input and/or output devices that directly perform actions as part of the automated process or directly acquire and further process parameters of the automated process belong to the field level. On the other hand, other devices that perform higher-order functions, e.g., the controlling of devices directly involved in the automation process, belong to the control level.

In another particularly preferred embodiment, the plurality of hierarchy levels additionally include a process control and/or management level disposed above the field level and the control level. These levels can either form a common layer or possibly can also be subdivided into two different levels, where the management level is above the process control level. Assigned to the process control and/or management level are the devices monitoring the automation plant and/or the devices disposed outside the automation plant, where the assignment to this level is again made based on the device type of the relevant devices. For assigning devices to the process control and/or management level, the device type is again taken into account. The devices that are assigned to the process control and/or management level can again be suitably defined in advance, depending on the application or the automation plant in question.

In another embodiment of the method in accordance with the invention, predetermined device types can each be assigned to two adjacent hierarchy levels and disposed between the corresponding sections of these hierarchy levels on the user interface. For example, all the devices of a predetermined device type can be positioned between the corresponding sections. If required, however, in addition to the device type criterion, another criterion can also be taken into account that will also inform the decision of whether a predetermined device type is actually positioned between adjacent hierarchy levels.

In another embodiment of the method in accordance with the invention, a determined network topology specifies different types of connections between the devices, where the different types of connections are visually differentiated on the user interface. For example, the types of connections can be differentiated so as to indicate whether wireline electrical connections or optical connections are involved. The connections can likewise be differentiated so as to indicate whether they are bus connections, e.g., based on Profibus, or Ethernet connections, based in particular on industrial Ethernet or Profinet.

In another embodiment of the method in accordance with the invention, the device types include types of Ethernet switches, control equipment, sensors, actuators and/or computers such as PCs or servers.

In another embodiment of the method in accordance with the invention, the device types are also taken into account in the arrangement of the devices within the hierarchy level, whereby predetermined pairs of device types that are directly interconnected according to the network topology are disposed adjacently or as one element on the display. As a result, a visual indication is provided of which devices are disposed in spatial proximity to one another or belong together. In particular, predetermined device types, for example, which are subassemblies belonging to the same rack or to the same module, can be displayed adjacently or as a common element. For example, a computer processor unit and the correspondingly assigned communications processor, e.g., comprising an Ethernet card, can be reproduced as one element or adjacently on the user interface.

In another embodiment of the method in accordance with the invention, sections corresponding to the hierarchy levels are disposed vertically one above the other on the user interface, where a section of a higher hierarchy level is positioned higher up on the user interface. This visually conveys the hierarchical structure of the automation plant in a particularly intuitive manner.

In another embodiment of the method in accordance with the invention, the device types are also taken into account in the positioning of the devices within a respective section corresponding to a hierarchy level. In particular, the location of the respective device in the section represents the proximity of the device or device type to the automation process of the automation plant. Thus, in a vertical arrangement of the hierarchy levels one above the other, device types that are closer to the automation process are positioned lower down in the corresponding section. Here, depending on the application, it is also possible to specify suitable criteria for the proximity of a device to the automation process, i.e., whether the device is directly or only indirectly involved in the automation process or whether the device is an automation plant component at all. In an alternative embodiment, whether the device types are positioned alongside one another or one below the other in the respective section is specified for predetermined pairs of two directly connected device types.

In another embodiment of the method in accordance with the invention, additional information concerning a respective device is displayed on the user interface for at least some of the devices, i.e., the device type and/or the IP address of the respective device.

In addition to the above described method, the invention also relates to an apparatus for computer-aided analysis of an automation plant to which a plurality of networked devices are assigned, where the device comprises the following components that can be suitably implemented as hardware and/or software:
a an acquisition device for acquiring information pertaining to the devices, including their device types and interconnections;
a generator device for generating a network topology that represents the networking of the devices;
an assigning device for assigning a respective device according to its type to one of a plurality of hierarchy levels defined for the automation plant;
a user interface for displaying a topology of the automation plant, where a section for each hierarchy level is provided on the user interface, and the devices assigned to a respective hierarchy level are disposed as elements in the section provided for the respective hierarchy level and are interconnected based on the networking according to the network topology.

The apparatus in accordance with the invention is implemented such that each of the above described embodiments of the method in accordance with the invention can be performed using the apparatus.

The invention additionally relates to a non-transitory machine-readable media encoded with a computer program for performing the method in accordance with the disclosed embodiments of the invention when the program is run/executed on a computer.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the invention will now be described in detail with reference to the accompanying drawings in which:

FIG. 1 schematically illustrates an automation plant topology that was generated based on an embodiment of the method in accordance with the invention;

FIG. 2 schematically illustrates another automation plant topology showing assignment of devices to hierarchy levels based on an embodiment of the invention; and

FIG. 3 is a flow chart of a method in accordance with an embodiment of the invention.

### DETAILED DESCRIPTION OF THE PRESENTLY PREFERRED EMBODIMENTS

In accordance with the disclosed embodiments of the method which are described below, a suitable topology of an automation plant comprising a plurality of hierarchy levels is generated based on information from individual devices that are directly or indirectly assigned to the automation plant. For this purpose, information about the individual devices is first collected during operation of the automation plant in a corresponding monitoring unit that is used for performing the method in accordance with the disclosed embodiments of the invention. In particular, the information is collected by the monitoring unit using a network protocol, where the conventional Simple Network Management Protocol (SNMP) is preferably used. Information pertaining to the individual devices is additionally exchanged between adjacent devices based on the conventional Link Layer Discovery Protocol (LLDP). In each device, information pertaining to the device itself and its adjacent devices is stored locally in a Management Information Base (MIB). In accordance with the contemplated embodiment, this information is read from all the devices by the monitoring unit using SNMP. Based on this information, the network topology between the devices can then be inferred using methods that are known per se, where the topology initially contains no additional information pertaining to the corresponding types of the devices. Nevertheless, the information pertaining to the device types of the individual devices has been read from the MIBs of the devices and is suitably processed after generation of the network topology, as will be described in greater detail below.

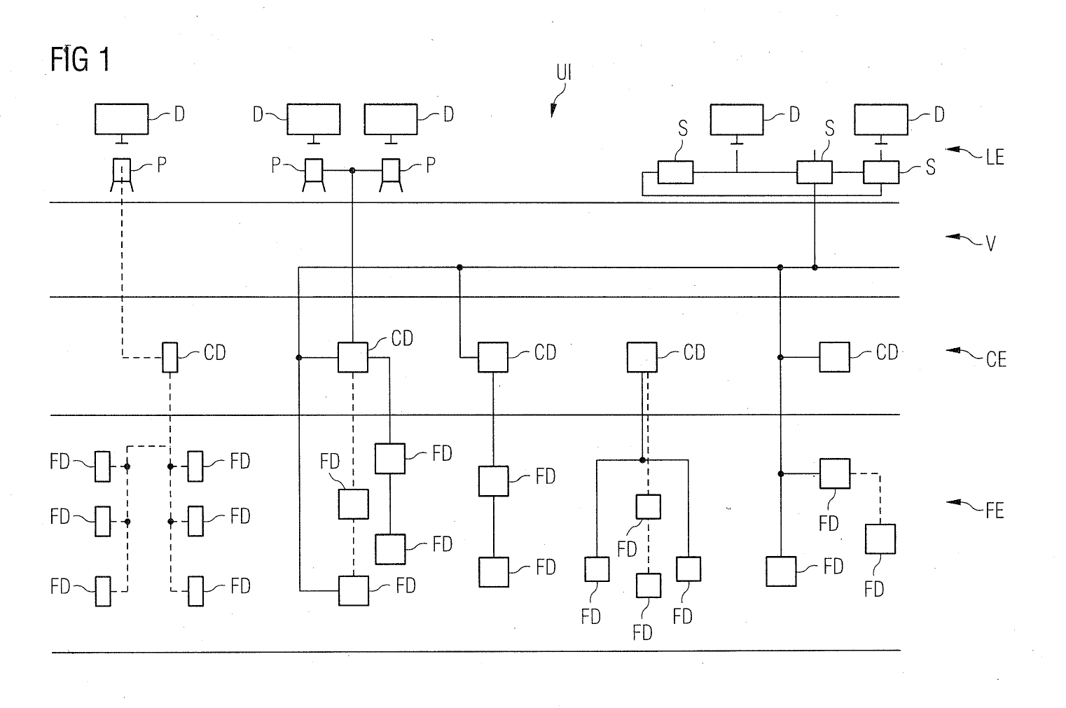

Within the scope of the contemplated embodiments of method in accordance with the invention, a plurality of hierarchy levels are defined for the automation plant in question, where the hierarchy levels are based on corresponding levels of a conventional automation pyramid. Corresponding devices that differ in their relational functionalities in can be assigned to each hierarchy level to the automation plant. Based on the hierarchy levels, the topology of the automation plant is reproduced on a user interface in accordance with the disclosed embodiments of the invention, where FIG. 1 is an exemplary topology with the corresponding hierarchy levels.

In the example of FIG. 1, which reproduces a display in accordance with the disclosed embodiments of the invention on a user interface UI, three hierarchy levels FE, CE and LE are considered, where each hierarchy level is assigned a vertical section on the display. Here, the hierarchy level FE corresponds to a field level containing field devices FD that are directly involved in the manufacturing or production process performed with the automation plant. These are in particular corresponding actuators or sensors, input and/or output devices, and possibly switching devices that switch the other FE level devices. Connected to the field level FE is a next-higher hierarchy level CE representing a control level containing higher-order control devices CD that control groups of corresponding field devices FD. Contiguous with this level CE is another level V that does not constitute a hierarchy level within the meaning of the disclosed embodiments of the invention, but merely illustrates the Information technology (IT) networking of the CE level with the next higher hierarchy level LE which is known as the process control level and contains, among other things, devices that monitor the overall automation plant, i.e., devices of IT networks that although connected to the automation plant are not a direct part of the automation plant. These can be, e.g., devices of a network of a company responsible for the planning, design and operation of the automation plant.

As an example of LE level devices, FIG. 1 shows three computers comprising PC's P with corresponding visual display units D. Also shown as additional LE level devices are servers S which can be accessed through corresponding visual display units D. In the exemplary embodiment of FIG. 1, the computers P in the left-hand part of the figure belong to a corresponding corporate network that is linked to the automation plant. These computers can be, e.g., engineering stations or more specifically telephone servers or other computers. In contrast, the servers S in the right-hand part of the process control level LE constitute corresponding computers that can be used for diagnostics or for monitoring the real-time operation of the technical system. Here it is possible to use well known monitoring systems with appropriate software, e.g., based on the WinCC server. The exemplary schematic block diagram depicted in FIG. 1 is preferably generated on the diagnostic or monitoring server S and displayed on a corresponding display D.

In the example illustrated in FIG. 1, the individual interconnections between the devices are indicated by continuous lines, on the one hand, and by dashed lines on the other. The continuous lines represent Ethernet connections based on the known Profinet standard, while the dashed lines in FIG. 1 represent connections based on the known Profibus standard. Instead of differentiating between the connections using continuous or dashed lines, if required, it is also possible to render the connections in different colors. As evident from FIG. 1, the computer P at the left-hand edge of FIG. 1 is used solely to control corresponding devices using the Profibus standard, whereas the other computers P and the servers S are used to interconnect devices both using Profinet and Profibus. FIG. 1 also shows that one control device CD in the CE level operates autonomously and is not monitored by devices in higher hierarchy levels. This unmonitored control device is the fourth control device from the left and can comprise, for example, a test station having a corresponding panel for inputting and outputting values.

It should be clearly understood that the representation in FIG. 1 is merely schematic, i.e., the individual devices are only conveyed by schematically indicated components. It should also be understood that the reference characters shown in FIG. 1 do not form part of the display. The individual devices are preferably reproduced as icons that pre-suggest the function of the individual devices. In addition, information pertaining to the various devices is rendered as text fields (not shown for reasons of clarity) adjacent to the individual icons, so that a user can quickly identify the devices. In addition to the device names, further information pertaining to the devices, e.g., corresponding IP addresses of the devices in the network, can be displayed inside the text fields if required.

The exemplary automation plant shown in FIG. 1 can be any industrial plant for controlling an automated process. For example, the plant in FIG. 1 can be a drink bottling plant, where in this case the individual control devices CD are assigned to corresponding stations in the bottling plant, such as a belt conveyor, a pallet for drink bottles, a capping station for filled bottles, a de-capping station for returned bottles, a recycling station for returned bottles, test stations, units for gripping bottles or a station for filling the bottles.

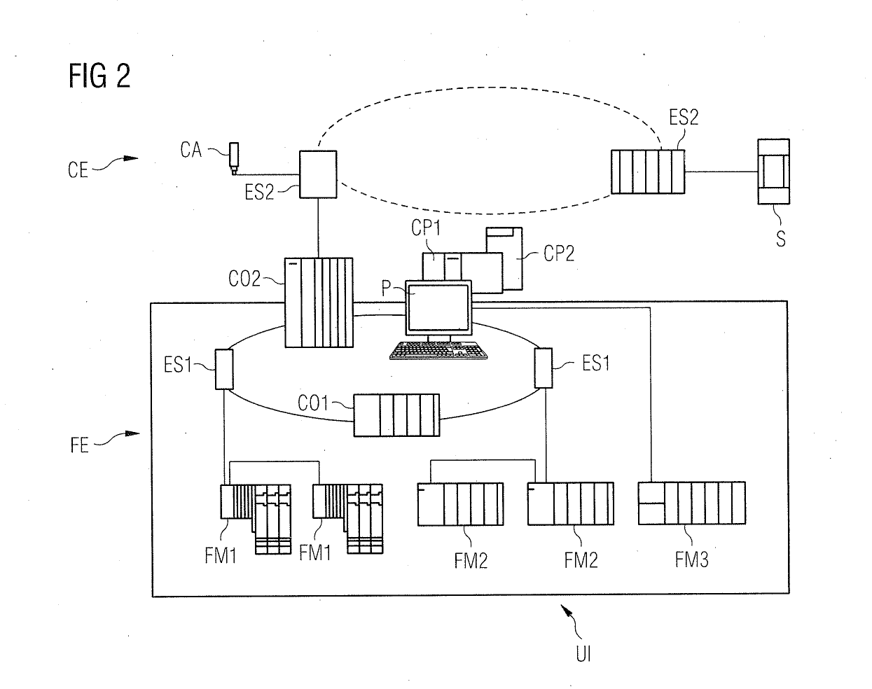

FIG. 2 is a schematic block diagram of an alternative visualization of the topology of an automation plant on a user interface UI comprising a display unit in accordance with an alternative embodiment of the invention. Here, as described above, the correspondingly shown reference characters do not form a part of the display. In addition, information pertaining to the individual devices is displayed as text fields (not shown) adjacent to the devices. In contrast to FIG. 1, the automation plant that is reproduced here has only two hierarchy levels comprising a field level FE and a control level CE.

With specific reference to FIG. 2, it will now be explained how the assignment to hierarchy levels can occur as a function of correspondingly read out device types. AS shown in FIG. 2, a plurality of Ethernet switches are provided In the exemplary automation plant, where the individual Ethernet switches belong to different switch series. The Ethernet switches ES1 constitute types of Ethernet switches of one series, while the Ethernet switches ES2 belong to another series. In particular, the Ethernet switches ES1 are Ethernet switches of the SCALANCE X200 series of Siemens AG (e.g. SCALANCE X204IRT or SCALANCE X208). In contrast to the ES1 switches, the ES2 switches disposed in the control level CE belong to the SCALANCE X300 series. In particular, the ES2 Ethernet switch shown in the control level in the left-hand part of FIG. 2 is a SCALANCE X308-2 switch, while the ES2 Ethernet switch in the right-hand part of FIG. 2 is a SCALANCE X408-2 Ethernet switch.

Based on the presently described embodiment, all the switches of the SCALANCE X200 series and also the lower SCALANCE X100 series are positioned in the field level FE, as they are used for direct switching of devices used in the field of the automation plant. In FIG. 2, corresponding field devices are denoted by reference characters FM1, FM2 and FM3. The individual devices constitute corresponding types of functional modules of the SIMATIC series of Siemens AG. In particular, the devices FM1 are ET 200S modules, the devices FM2 are ET 200pro modules and the FM3 is an ET 200M module. In accordance with the disclosed embodiments, all these device constitute field devices and are disposed in the field level FE. The individual functional modules are used for performing corresponding tasks in the field depending on the automation system in question, such as counting, positioning, controlling or adjusting.

In the field level FE depicted in FIG. 2, corresponding production controllers CO1 and CO2 are provided as additional devices, where corresponding device types of the controllers are likewise disposed in the field level FE. In addition, controllers of a particular type are disposed both in the field level FE and in the control level CE as an interface between the two levels. The controller CO2 shown in FIG. 2 constitutes such a controller, where it is readily appreciable from a corresponding graphical representation that the controller belongs to both FE and CE levels. In contrast to the controller CO2, the type of the controller CO1 is uniquely assigned to the field level FE.

FIG. 2 also depicts a corresponding control PC P which, analogously to the controller CO2, is again assigned to both levels FE and CE as an interface. The PC is, e.g., a Microbox PC of Siemens AG that is configured for use in automation plants. In accordance with the disclosed embodiments, such PCs belong at least to the control level and, depending on type, possibly also to the field level and in some cases to the field level only. The PC P comprises corresponding communications processors CP1 and CP2 (e.g., type CP1616/CP1604 processors of Siemens AG). In accordance with the presently contemplated embodiment, it could be determined based on the network topology that these processors are a component part of the PC P. In the exemplary embodiment shown in FIG. 2, such communications processors, which in particular constitute corresponding network cards, are disposed in the immediate vicinity of the corresponding device in which they are incorporated, i.e., are no longer represented as a separate element in the display. In particular, the controllers CO1 and CO2 already contain the corresponding communications processors. Appropriate text fields (not shown for reasons of clarity) on the controllers CO1 or CO2 indicate the type of controller involved and which processors they contain. In the embodiment of FIG. 2, the controller CO1 is a SIMATIC S7-300 controller with a CP343-1 Advanced communications processor of Siemens AG. In contrast, the controller CO2 is a SIMATIC S7-400 controller with a CP443-1 Advanced communications processor of Siemens AG.

Analogously to the embodiment in FIG. 1, corresponding connections between the individual devices represented are indicated by lines, with continuous lines representing electrical Ethernet connections. Additionally present are dashed lines between the two Ethernet switches ES2 in the control level CE, where these lines represent a fiberoptic Ethernet connection. In FIG. 2, a camera CA is also shown in the control level CE, which is connected to the Ethernet switch ES2 in the left-hand part of FIG. 2. Also shown is a server S comprising a WinCC server having a CP1623 communications processor that is connected to the Ethernet switch ES2 in the right-hand part of FIG. 2. In accordance with the exemplary embodiment depicted in FIG. 2, the camera CA and the server S both belong to the control level CE.

As appreciable from FIG. 2, different sublevels are also provided within the individual hierarchy levels. Account is taken within the framework of the method in accordance with the embodiments of the invention of which pairs of devices are directly interconnected to achieve the arrangement of devices in such sublevels within a hierarchy level. In the topology shown in FIG. 2, for example, it is taken into account that directly interconnected functional modules are always disposed next to one another on the same sublevel of the hierarchy level FE, while the connection of an Ethernet switch to a functional module results in a transition from one sublevel to a lower sublevel in the hierarchy level FE. The individual sublevels in the other hierarchy levels or between other devices can be generated in the same way based on corresponding information.

The above described embodiments of the method in accordance with the invention are merely examples. In particular, depending on the automation plant in question, any hierarchy levels for describing the topology of the automation plant can be defined, where lower hierarchy levels specify devices that are closer to the manufacturing or production process performed by the automation plant. In accordance with the contemplated embodiments of the invention, the corresponding network topology between the individual devices is initially generated, which initially represents merely the connections between the individual devices. A meaningful representation for describing the automation plant is then produced as a hierarchical structure based on or corresponding to levels of the automation pyramid. This representation is generated automatically and there is no need for a corresponding user to manually configure the hierarchical structure, as is the case with conventional automation plants.

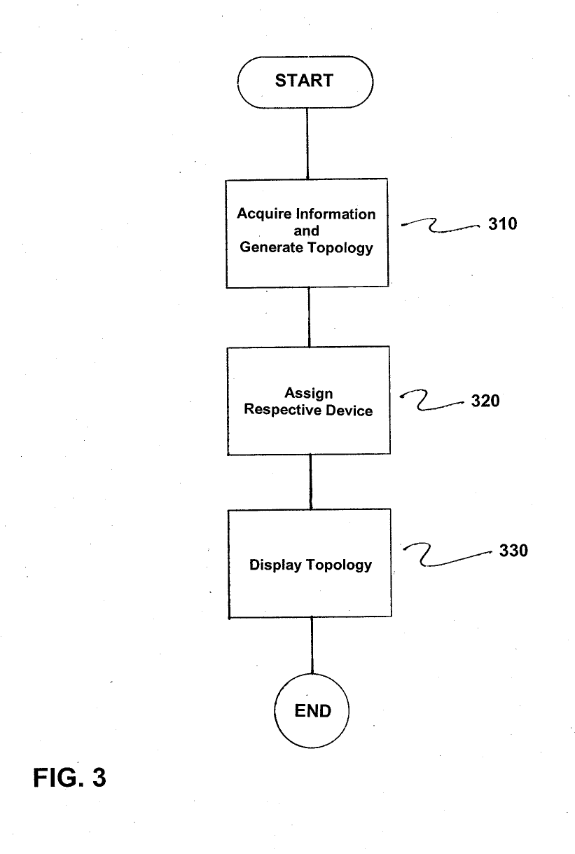

FIG. 3 is a flow chart of a method for computer-aided analysis of an automation plant to which a plurality of networked devices are assigned. The method comprises acquiring information pertaining to each of the plurality of networked devices and generating a network topology representing a networking of each of the plurality of networked devices, as indicated in step 310. Here, the information includes device types and interconnections of the plurality of networked devices.

A respective device of the plurality of networked devices is assigned according to its device type to a hierarchy level of a plurality of hierarchy levels defined for the automation plant, as indicated in step 320. A topology of the automation plant is displayed on a user interface upon which a section is provided for each of the plurality of hierarchy levels, as indicated in step 330. Here, devices of the plurality of networked devices that are assigned to a respective hierarchy level are disposed as elements in a section provided for a respective hierarchy level and are interconnected based on the networking of the plurality of networked devices according to the generated network topology.

The method in accordance with the disclosed embodiments of the invention therefore involves automatic generation of corresponding automation plant topologies that are suitably displayed on a user interface. A user is thus quickly provided with a picture of the structure of the automation plant that is much more informative than merely reproducing the network structure of the interconnected devices. The display that is generated in accordance with the embodiments of the invention can be used as part of the monitoring of this automation plant to enable a user, in the event of failures of network connections, to identify quickly the part of the automation plant that is affected. In the displayed topology of the automation plant, failures can be indicated by appropriate warning messages or by highlighting failed data connections.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for computer-aided analysis of an automation plant to which a plurality of networked devices are assigned, comprising:
acquiring information pertaining to each of the plurality of networked devices and generating a network topology representing a networking of each of the plurality of networked devices, the information including device types and interconnections of the plurality of networked devices;
assigning a respective device of the plurality of networked devices according to its device type to a hierarchy level of a plurality of hierarchy levels defined for the automation plant; and
displaying a topology of the automation plant on a user interface upon which a section is provided for each of the plurality of hierarchy levels, devices of the plurality of networked devices assigned to a respective hierarchy level being disposed as elements in a section provided for a respective hierarchy level and being interconnected based on the networking of the plurality of networked devices according to the generated network topology.

2. The method as claimed in claim 1, wherein the assignment of a device of the plurality of networked devices to a hierarchy level represents a proximity of the device to an automation process of the automation plant, and wherein a lower hierarchy level has a greater proximity to the automation process.

3. The method as claimed in claim 1, wherein the plurality of hierarchy levels comprise a field level and a control level, and wherein devices of the plurality of networked devices directly involved in the automation process of the automation plant are assigned to the field level and devices of the plurality of networked devices indirectly involved in an automation process of the automation plant are assigned to the control level.

4. The method as claimed in claim 2, wherein the plurality of hierarchy levels comprise a field level and a control level, and wherein devices of the plurality of networked devices directly involved in the automation process of the automation plant are assigned to the field level and devices of the plurality of networked devices indirectly involved in the automation process of the automation plant are assigned to the control level.

5. The method as claimed in claim 3, wherein the plurality of hierarchy levels include, disposed above the field level and the control level, at least one of a process control level and management level, at least one of devices of the plurality of networked devices monitoring the automation plant and devices of the plurality of networked devices disposed outside the automation plant being assigned to the at least one of the process control level and management level.

6. The method as claimed in claim 1, wherein predetermined device types are assignable to two adjacent hierarchy levels and are disposable on the user interface between corresponding sections of the plurality of hierarchy levels.

7. The method as claimed in claim 1, wherein the network topology specifies different connection types between each of the plurality of networked devices, the different connection types being visually differentiated on the user interface.

8. The method as claimed in claim 6, wherein the device types comprise at least one type of Ethernet switch, control device, sensor, actuator or computer.

9. The method as claimed in claim 1, wherein predetermined pairs of device types that are directly interconnected according to the network topology are disposed adjacently or as a common element on the user interface.

10. The method as claimed in claim 1, wherein for the assignment of devices of the plurality of networked devices to hierarchy levels of the plurality of hierarchy levels, a device type and an installation location of the respective device are taken into account.

11. The method as claimed in claim 1, wherein user interface sections corresponding to the plurality of hierarchy levels are disposed vertically above one another, a section of a higher hierarchy level being positioned at higher level on the user interface.

12. The method as claimed in claim 1, wherein devices of the plurality of networked devices are positioned within a respective section corresponding to a hierarchy level of the plurality of hierarchy levels according to their device types, a position of the respective device in the respective section representing a proximity of the device of the plurality of networked devices to an automation process of the automation plant.

13. The method as claimed in claim 10, further comprising:
specifying whether device types are positioned next to one another or below one another in a respective section for predetermined pairs of two directly connected device types.

14. The method as claimed in claim 1, wherein information pertaining to the respective device is reproduced on the user interface for at least some of the devices of the plurality of networked devices, wherein the information comprises at least one of the device type and an IP address of the respective device.

15. An apparatus for computer-aided analysis of an automation plant to which a plurality of networked devices are assigned, comprising:
an acquisition device configured to acquire information pertaining to each of the plurality of networked devices, the information comprising device types and interconnections;
a generation device configured to generate a network topology representing networking of the plurality of networked devices;
an assignment device configured to assign a respective device of the plurality of networked devices according to its device type to a hierarchy level of a plurality of hierarchy levels defined for the automation plant;
a user interface configured to display a topology of the automation plant and upon which a section is provided for each hierarchy level of the plurality of hierarchy levels, devices of the plurality of networked devices assigned to a respective hierarchy level being disposed as elements in the section provided for the respective hierarchy level of the plurality of hierarchy levels and being interconnected based on networking according to the network topology.

16. A non-transitory machine-readable media encoded with a computer program having a program code which, when used on a computer, causes computer-aided analysis of an automation plant to which a plurality of networked devices are assigned, the computer program comprising:
program code for acquiring information pertaining to each of the plurality of networked devices and generating a network topology representing a networking of each of the plurality of networked devices, the information including device types and interconnections of the plurality of networked devices;
program code for assigning a respective device of the plurality of networked devices according to its device type to a hierarchy level of a plurality of hierarchy levels defined for the automation plant; and
program code for displaying a topology of the automation plant on a user interface upon which a section is provided for each of the plurality of hierarchy levels, devices of the plurality of networked devices assigned to a respective hierarchy level being disposed as elements in a section provided for a respective hierarchy level and being interconnected based on the networking of the plurality of networked devices according to the generated network topology.
